(19) United States
(12) Patent Application Publication
(10) Pub. No.: US 2009/0024755 A1
(43) Pub. Date: Jan. 22, 2009

(54) Method And Apparatus For Transferring Large Quantities Of Data

(76) Inventors: Amit Singh Rathore, Leeds (GB); Ashish Awasthi, Bangalore (IN); Sathyamurthy Dattathreya, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/944,459

(22) Filed: Nov. 22, 2007

(30) Foreign Application Priority Data
Jul. 16, 2007 (IN) 1521/CHE/2007

(51) Int. Cl. G06F 15/16

(52) U.S. Cl. 709/231

(57) ABSTRACT

A method and system for transferring data in a computing environment. In one embodiment the method comprises sending a request for the data to a web service, the request comprising web service information; the web service responding by fetching the data from a data storage; storing the data in at least one file; generating a Uniform Resource Identifier for the file; receiving the Uniform Resource Identifier; and receiving the data as a data stream from the file.

### BACKGROUND OF THE INVENTION

A Web Service is software that supports interoperable interaction of computing devices over a network. As Web Services become more common, the complexity of the tasks they perform is likely to increase and the amount of data they process to increase. How the transfer of data is handled can affect the usability of the Web Service. For example, a Monitoring and Reporting Service may need repeatedly to transfer large amounts—even gigabytes—of data.

A standard protocol for exchanging XML-based messages over a computer network is SOAP (Simple Object Access Protocol). SOAP messages are used to transmit messages over a transport protocol, such as HTTP, in Web Services based applications; this is currently the standard approach in the Web Services paradigm. SOAP engines are used for creation and transportation of SOAP messages with the data to be transferred. Existing SOAP engines can handle small SOAP messages efficiently but when they encounter large amount of data bundled into a SOAP message, SOAP engines can experience performance and reliability problems.

In particular, data sent via SOAP message is encoded so, as the amount of data increases, the encoding also increases leading to performance problems. Processing unexpectedly large amounts of data by SOAP engines unpredictably increases access latency and leads to session timeouts. This makes this approach unreliable for transferring large quantities of data. Furthermore, security is introduced at the message-level using WS-Security (Web Service Security), but encrypting large amounts of data increases the overall processing time taken by the SOAP engine.

SOAP with Attachments is used to transfer binary data files. SOAP messages can be transmitted with attachments of various types (such as images, drawings and text documents). Such data is often in a particular binary format and uses the “MIME or DIME multipart/related” content type and URI (Uniform Resource Identifier) schemes for referencing the MIME or DIME parts.

However, this scenario also leads to low performance owing to the additional processing time required to encode the data into a standard binary format (such as base64) and decode it at the client. In addition, interoperability using SOAP attachments is a problem, as each SOAP engine vendor has a proprietary protocol to interpret binary data objects. For example, Java based SOAP engines and Microsoft .NET or C++SOAP engines define binary data objects differently: Java based SOAP engines support MIME whereas .NET based SOAP engines support the Microsoft proprietary protocol DIME.

Furthermore, WSDL (Web Services Description Language, an XML format for describing network services) has to be modified to accommodate different MIME content types and reduces flexibility to send different MIME content types via the same Web Service. For example, an image and a PDF document have different MIME content type descriptions in WSDL.

Alternatively, large quantities of data may be broken into smaller chunks of a fixed size for transfer. The number of method calls is then proportional to the number of data chunks. These data chunks must be managed efficiently to transfer the correct set of data chunks and subsequently to reassemble the data chunks correctly. Thus, such techniques have poor performance owing to the additional processing time required by serialization and the establishment of connections to the server for every chunk. They also have poor usability and manageability metrics, as the consumer of the Web Service must add functionality to the client code to manage the received chunks in a reliable manner. Indeed, the size of a data chunk cannot be predicted on the client-side code, so the server-side code must be adapted to pass information on optimal chunk size to the client, that is, the chunk size that both server and client-side are expected to be able to handle. Finally, very large transfers can potentially suffer from unpredictable delays and may result in loss of data.

### BRIEF DESCRIPTION OF THE DRAWING

In order that the invention may be more clearly ascertained, embodiments will now be described, by way of example, with reference to the accompanying drawing, in which:

FIG. 1 is a schematic view of a computing system according to an embodiment of the present invention.

FIGS. 2A and 2B constitute a flow diagram of a method implemented in the system of FIG. 1 according to an embodiment of the present invention.

FIGS. 3A and 3B constitute a flow diagram of another method implemented in the system of FIG. 1 according to an embodiment of the present invention.

FIG. 4 is a graph of experimental results obtained with the method implemented according to the embodiment of FIG. 1, and of comparison experimental results obtained with methods of the background art.

### DETAILED DESCRIPTION OF THE EMBODIMENTS

There will be provided a method and apparatus for transferring data in a computing environment.

In one embodiment, the method comprises sending a request for the data to a web service, the request comprising web service information; the web service responding by fetching the data from a data storage; storing the data in at least one file; generating a Uniform Resource Identifier for the file; receiving the Uniform Resource Identifier; and receiving the data as a data stream from the file.

In one embodiment, the computing system comprises a client having a client module and a server having a web service. In this embodiment, the client is configured to respond to a request comprising web service information from a consumer of the web service for the data to forward the request to the web service, the web service is configured to respond to the request by fetching the data from a data storage and passing the data to the server, the server is configured to store the data in at least one file, generate a Uniform Resource Identifier for the file and return the Uniform Resource Identifier to the web service, the web service is further configured to return the Uniform Resource Identifier to the client, and the client is further configured to respond by opening a data stream with the Uniform Resource Identifier to receive the data.

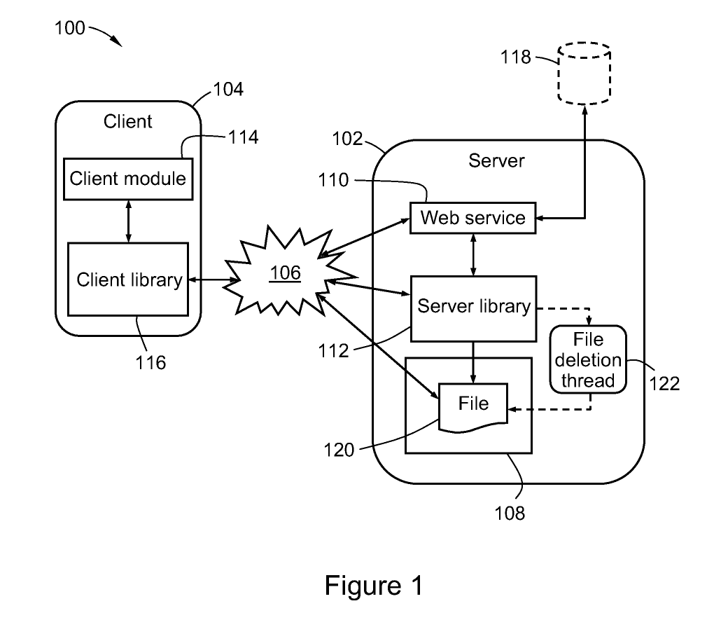

FIG. 1 is a schematic view of a computing system 100 according to an embodiment of the present invention. System 100 includes a server 102 and a client 104 (which may be running on a client computer or, indeed, also on a server computer that constitutes or includes server 102).

Computing system 100 includes communications infrastructure 106 to which server 102 and client 104 are connected, so that server 102 and client 104 are in data communication. Communications infrastructure 106, in this embodiment, comprises an intranet but in other embodiments may comprise the internet or other computer network.

Server 102 has a web container 108, a Web Service 110 and a server library 112 (a software component discussed below). Client 104 has a client module 114 (viz. a software component that is the effective client for Web Service 110) and a client library 116 (a software component, also discussed below).

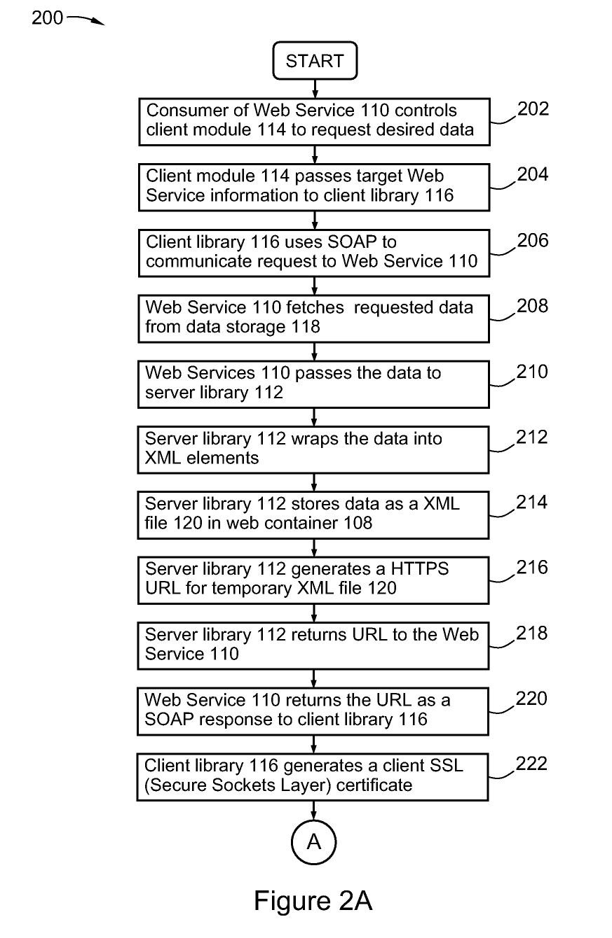

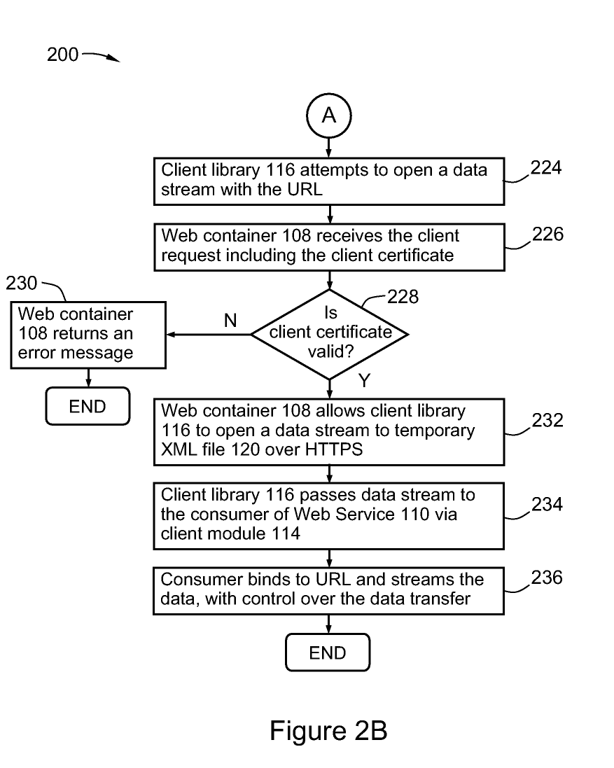

The features of computing system 100 are most clearly illustrated by reference to FIGS. 2A and 2B, which constitute a flow diagram 200 of the operation of system 100 when a consumer (in client 104) of Web Service 110 requests data resident on a data storage 118 (shown dashed). Data storage 118, it should be noted, is in data communication with server 102; this can be by any suitable method, whether via a computer network (such as intranet 106 or the internet). Indeed, in some embodiments, data storage 118 is a part of computing system 100. Data storage 118 may comprise any form of data storage device or system, including—for example—a RDBMS (Relational Database Management System), a flat file, a legacy system or log files.

Thus, referring to FIGS. 2A and 2B, at step 202 the consumer of Web Service 110 controls client module 114 to request the desired data. At step 204, client module 114 passes target Web Service information pertaining to the desired data, such as port and service method name, to client library 116. This is essentially a getData( ) call to client library 116. At step 206, client library 116 responds by communicating the request using SOAP to Web Service 110 (which is responsible for accessing large volumes of data from data storage 118).

At step 208, Web Service 110 fetches the requested data from data storage 118, then at step 210 passes the data either as an object containing data rows or as a stream of data to server library 112. In this embodiment, if the data is essentially in rows and columns (which will commonly be the case), at step 212 server library 112 wraps the data into XML (Extensible Markup Language) elements, and at step 214 stores the data as a temporary XML file 120 on server 102 in web container 108.

At step 216, server library 112 generates a HTTP URI (Uniform Resource Indicator) in the form of a HTTPS URL (Uniform Resource Locator) for temporary XML file 120 and at step 218 returns this URL to the Web Service 110. At step 220 Web Service 110 returns the URL as a SOAP response to client library 116.

For reasons of security, client library 116 generates—at step 222—a client SSL (Secure Sockets Layer) certificate. At step 224, client library 116 attempts to open a data stream with the URL by accessing temporary XML file 120 (which has an HTTPS URL). At step 226, Web container 108 receives the client access request in the form of an HTTPS “Open( )” call with two parameters, the URL and the client certificate. Web container 108 is configured to validate client certificates that are received along with a client request. Hence, Web container 108 responds—at step 228—by validating (i.e. checking the validity of) the client certificate. If the client certificate is not validated (i.e. the request is not from a trusted client), processing continues at step 230 where web container 108 returns an error message and processing ends.

Otherwise (i.e. the request is found to be from a trusted client) processing continues at step 232, where web container 108 allows client library 116 to open a stream to the temporary XML file 120 over HTTPS. At step 234 client library 116 passes this stream to the consumer of Web Service 110 via client module 114. At step 236 the consumer binds to the URL and streams the data, while having control over the data transfer.

At this point processing essentially ends. However, temporary XML files created in web container 108 consume disk space so, to manage these files, server 102 includes a singleton thread utility 122 that is initiated by server library 112 when the first such temporary XML file is created in web container 108. Once started, the thread 122 remains alive and running for the lifetime of Web Service 110 or web container 108. Thread 122 polls periodically, validates each temporary XML file 120 against its timestamp and deletes files that are old. The time interval between polling and the file retention period are configurable by accessing server library 112 with Web Service 110. The consumer has access to temporary XML file 120 within the file retention period; otherwise the consumer will have to make another call to Web Service 110 to create a new temporary XML file 120.

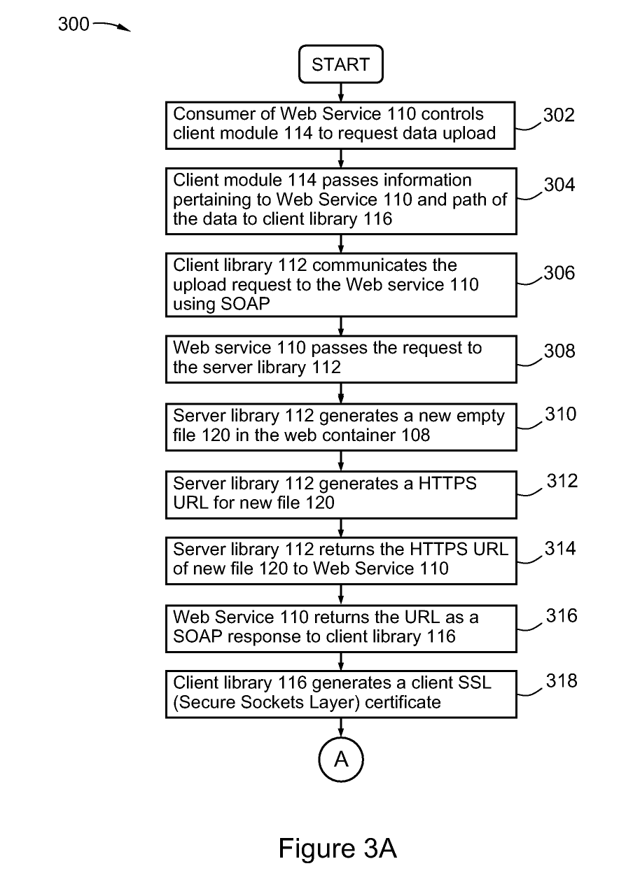

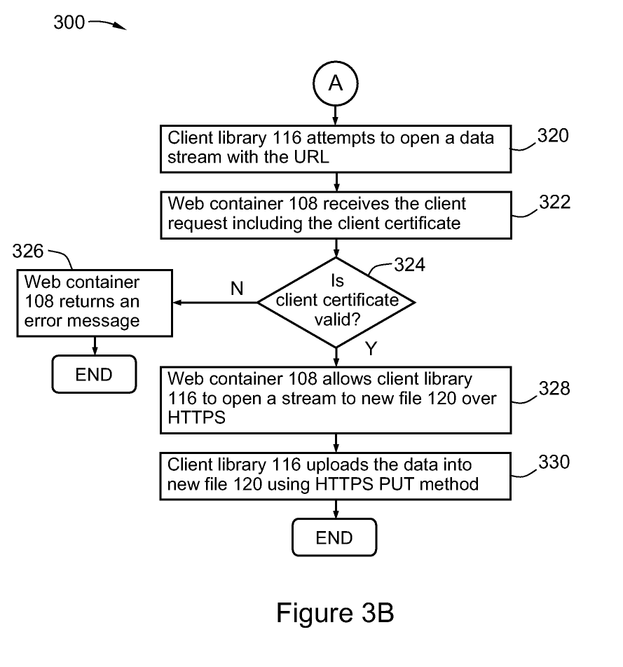

According to this embodiment, it is also possible to upload data. FIGS. 3A and 3B constitute a flow diagram 300 of the operation of system 100 when a consumer (in client 104) of Web Service 110 requests the uploading of a local data file onto Web service 110.

Thus, referring to FIGS. 3A and 3B, at step 302 the consumer of Web Service 110 controls client module 114 to request the uploading of data. At step 304, client module 114 passes the upload request—comprising information pertaining to Web Service 110, such as port and service method name, and the path to the file containing the data to be uploaded—to client library 116. At step 306, client library 116 responds by communicating the upload request to Web Service 110 using SOAP.

At step 308, Web Service 110 passes the request to server library 112. At step 310, server library 112 creates a new empty file 120 on server 102 in web container 108.

At step 312, server library 112 generates a HTTPS URL for the new file 120 and at step 314 returns this URL to the Web Service 110. At step 316 Web Service 110 returns the URL as a SOAP response to client library 116.

For security, client library 116 generates—at step 318—a client SSL certificate. At step 320, client library 116 attempts to open a data stream with the URL to access new file 120 (which has an HTTPS URL). At step 322, Web container 108 receives the client access request in the form of an HTTPS “Open( )” call with two parameters, the URL and the client certificate. Web container 108 is configured to validate client certificates that are received along with a client request. Hence, Web container 108 responds—at step 324—by validating the client certificate. If the client certificate is not validated, processing continues at step 326 where web container 108 returns an error message and processing ends.

Otherwise (i.e. the request is found to be from a trusted client) processing continues at step 328, where web container 108 allows client library 116 to open a stream to new file 120 over HTTPS. At step 330 client library 116 uploads the local data file to new file 120 on server 102 using, in this embodiment, the PUT method, while having control over the data transfer. The PUT method requests that an enclosed entity be stored at the supplied Request-URI (in this case the HTTPS URL). Processing then ends.

### Experiment

A computing system was constructed according to the embodiment of FIG. 1, with a standard test and development environment using Sun brand Java as implementation language with JDK1.5 (Java Development Kit 1.5), Apache brand Tomcat 5.5.17 as the Web Container, Apache Axis 1.3 as the Web Services middleware and a SOAP engine. Web Services and the client were running on an HP xw8200 Workstation with hardware configuration of Intel® Xeon 3.60 GHz processor, 2 GB RAM (Random Access Memory), with a Windows XP brand operating system. The Tomcat Web Container was configured with an initial memory of 128 MB (megabytes) and a maximum memory pool of 256 MB.

A Monitoring Web Service was employed to collect monitoring information on various resources from an OPENVIEW Reporter database on a monthly basis. The consumer of this Monitoring Web Service accesses this data for performance analysis of resources for a particular month. This monitoring information extends up to several megabytes or gigabytes of data. The consumer of this Web Service was integrated with the Client Library and the Monitoring Web Service is integrated with the Server Library.

The application was tested with three approaches for transferring a large volume of data, the first and second according to the background art. In the first or “Standard Approach”, the entire data was passed within a SOAP message; the second approach was the SOAP with Attachments approach. The third approach was according to the embodiment of the present invention described above by reference to FIGS. 1, 2A and 2B.

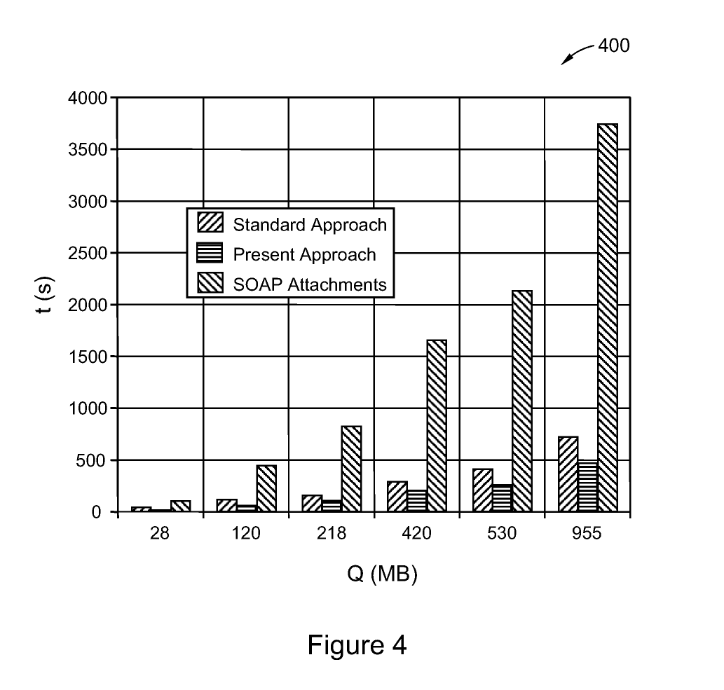

FIG. 4 is a bar graph that depicts performance and reliability for these three approaches, for transferring a fixed amount of data in the test and development environment described above. The graph 400 plots the time t (s) to transfer the data (or session timeout with loss of data) against the quantity Q (MB) of data transferred (or attempted to be transferred).

It was found that, for all data sizes, the Standard Approach timed out or ‘crashed’ resulting in a loss of data. The SOAP with Attachments approach and the approach of the present embodiment both succeeded in transferring the data, but the time taken to transfer the 28 MB, 120 MB, 218 MB, 420 MB, 530 MB and 955 MB of data with the approach of the present embodiment was, respectively, 14%, 13%, 13%, 12%, 12% and 12% of the time required using SOAP with Attachments.

Thus, with the method of the present embodiment, performance of a SOAP engine improves significantly as this method processes small SOAP messages with payloads of only a HTTPS URL. A large volume of data can be transferred, by data streaming over HTTPS. Data encryption is left to HTTPS and hence there is no additional overhead to encrypt the data with another security mechanism (such as WS-Security). Only two server calls are required to transfer a large volume of data, the first to the target Web Service while the second is a HTTPS call to transfer data from the temporary XML file.

As a large volume of data is not sent within a SOAP message, delays are avoided that might otherwise arise from accessing the data by the consumer; this also avoids probable session timeouts. The use of a data streaming mechanism using HTTP (a standard and reliable transport protocol) improves reliability and hence data integrity.

Security is provided via a transport-level security mechanism, that is, HTTP over SSL (HTTPS). HTTP and SSL are thus leveraged to potentially encrypt the data while it is on the wire because no data is passed within SOAP messages. Hence, a mechanism message level security is not required so security is provided with an industry standard security based transport protocol.

Interoperability can also be achieved because approaches such as SOAP with Attachments that use proprietary protocols (such as DIME) are avoided. Rather, the industry standard HTTPS transport protocol is used to transfer the data.

System 100 may be configured to employ asynchronous message calls, as accessing large volumes of data synchronously may compel consumers to wait until the whole process of transferring data has been completed. In addition, the method implemented in system 100 may equivalently be used in reverse, that is, to upload data from consumer to the Web Service. In that case, the identity of client and server are effectively reversed.

The foregoing description of the exemplary embodiments is provided to enable any person skilled in the art to make or use the present invention. While the invention has been described with respect to particular illustrated embodiments, various modifications to these embodiments will readily be apparent to those skilled in the art, and the generic principles defined herein may be applied to other embodiments without departing from the spirit or scope of the invention. It is therefore desired that the present embodiments be considered in all respects as illustrative and not restrictive. Accordingly, the present invention is not intended to be limited to the embodiments described above but is to be accorded the widest scope consistent with the principles and novel features disclosed herein.

1. A method of transferring data in a computing environment, comprising:
sending a request for said data to a web service, said request comprising web service information;
said web service responding by fetching said data from a data storage;
storing said data in at least one file;
generating a Uniform Resource Identifier for said file;
receiving said Uniform Resource Identifier; and
receiving said data as a data stream from said file.

2. A method as claimed in claim 1, further comprising:
wrapping said data into one or more Extensible Markup Language elements; and
storing said data thus wrapped in said at least one file, whereby said file comprises an Extensible Markup Language file.

3. A method as claimed in claim 1, comprising passing said data stream to a consumer of said web service and binding said consumer to said Uniform Resource Identifier so that said consumer streams said data.

4. A method as claimed in claim 1, including said Web Service passing said data either as an object containing data rows or as a stream of data to a server library.

5. A method as claimed in claim 1, including sending said request using Simple Object Access Protocol.

6. A method as claimed in claim 1, including said web service passing said data to a server library, and said server library generating said Uniform Resource Identifier for said file and returning said Uniform Resource Identifier to said Web Service.

7. A method as claimed in claim 1, including said server returning said Uniform Resource Identifier to said web service and said web service returning said Uniform Resource Identifier to said client.

8. A method as claimed in claim 1, including returning said Uniform Resource Identifier as a Simple Object Access Protocol response.

9. A method as claimed in claim 1, including transmitting said data as a data stream from said Extensible Markup Language file only after validating a source of said request.

10. A method of transferring data in a computing environment, comprising:
receiving a request for said data at a web service, said request comprising web service information;
responding by fetching said data from a data storage;
storing said data in at least one file;
generating a Uniform Resource Identifier for said file;
forwarding said Uniform Resource Identifier; and
transmitting said data as a data stream from said file.

11. A method as claimed in claim 10, further comprising:
wrapping said data into one or more Extensible Markup Language elements; and
storing said data thus wrapped in said at least one file, whereby said file comprises an Extensible Markup Language file.

12. A method of retrieving data in a computing environment, comprising:
sending a request for said data to a web service, said request comprising web service information;
receiving a Uniform Resource Identifier of at least one file containing said data; and
receiving said data as a data stream from said file.

13. A method as claimed in claim 12, wherein said file comprises an Extensible Markup Language file containing said data wrapped into one or more Extensible Markup Language elements.

14. A computing system for transferring data, comprising:
a client having a client module; and
a server having a web service;
wherein said client is configured to respond to a request comprising web service information from a consumer of said web service for said data by forwarding said request to said web service, said web service is configured to respond to said request by fetching said data from a data storage and passing said data to said server, said server is configured to store said data in at least one file, generate a Uniform Resource Identifier for said file and return said Uniform Resource Identifier to said web service, said web service is further configured to return said Uniform Resource Identifier to said client, and said client is further configured to respond by opening a data stream with said Uniform Resource Identifier to receive said data.

15. A system as claimed in claim 14, wherein:
said client comprises a client library and said server comprises a server library;
said request is forwarded to said web service by said client library, said web service is configured to pass said data to said server library, said data is stored in said file by said server library, said Uniform Resource Identifier is generated by said server library and said Uniform Resource Identifier is returned to said web service by said server library; and
said web service is configured to return said Uniform Resource Identifier to said client library, and said data stream is opened by said client library in response thereto.

16. A system as claimed in claim 14, wherein said server library is configured to wrap said data into one or more Extensible Markup Language elements and said at least one file comprises at least one Extensible Markup Language file.

17. A system as claimed in claim 14, wherein said server library is configured to generate said Uniform Resource Identifier as a HTTPS Uniform Resource Identifier.

18. A system as claimed in claim 14, wherein said system is adapted to send said request using Simple Object Access Protocol and said web service is configured to return said Uniform Resource Identifier as a Simple Object Access Protocol response.

19. A method of uploading data in a computing environment, comprising:
a client sending an upload request to a web service, said request comprising web service information and data location information;
said web service creating a file;
generating a Uniform Resource Identifier for said file;
returning said Uniform Resource Identifier to said client;
said client opening a data stream with said Uniform Resource Identifier to access said file; and
said client uploading said data to said file.

20. A method as claimed in claim 19, including said client uploading said data to said file with a HTTP PUT method.

21. A method as claimed in claim 19, including sending said upload request to said web service using a Simple Object Access Protocol.

22. A method as claimed in claim 19, including said web service creating said file in a web container.

23. A method as claimed in claim 19, including returning said Uniform Resource Identifier to said client as a Simple Object Access Protocol response.

24. A method of uploading data in a computing environment, comprising:
receiving an upload request, said request comprising data location information;
creating a file;
generating a Uniform Resource Identifier for said file;
returning said Uniform Resource Identifier;
permitting opening of a data stream to said file; and
mediating a data stream comprising said data to said file.

25. A computer readable medium provided with program data that, when executed on a computing system or systems, implements the method of claim 1.

26. A computer readable medium provided with program data that, when executed on a computing system or systems, implements the method of claim 10.

27. A computer readable medium provided with program data that, when executed on a computing system or systems, implements the method of claim 19.
